(19) United States
(12) Patent Application Publication
(10) Pub. No.: US 2014/0004225 A1
(43) Pub. Date: Jan. 2, 2014

(54) VERY LOW COMMON SALT SOY SAUCE AND METHOD FOR PRODUCING SAME

(71) Applicants: Hiroyuki Akamatsu, Noda-shi (JP); Yoshikazu Endo, Noda-shi (JP); Yoshiaki Nakajima, Noda-shi (JP); Toshifumi Matsuda, Noda-shi (JP); Shigeki Tanizawa, Noda-shi (JP)

(72) Inventors: Hiroyuki Akamatsu, Noda-shi (JP); Yoshikazu Endo, Noda-shi (JP); Yoshiaki Nakajima, Noda-shi (JP); Toshifumi Matsuda, Noda-shi (JP); Shigeki Tanizawa, Noda-shi (JP)

(73) Assignee: KIKKOMAN CORPORATION, Noda-shi, Chiba (JP)

(21) Appl. No.: 14/005,857

(22) PCT Filed: Mar. 21, 2012
(86) PCT No.: PCT/JP2012/057221

§ 371 Date: Sep. 18, 2013

(30) Foreign Application Priority Data
Mar. 23, 2011 (JP) 2011-064852

(51) Int. Cl. A23L 1/238

(52) U.S. Cl. CPC A23L 1/238
USPC 426/46; 426/589

(57) ABSTRACT

The present invention addresses the problem of obtaining a very low common salt soy sauce which contains flavor component favorable for a soy sauce at high concentrations and has a common salt concentration of 1.0 to 4.0% (w/v) and an ethanol concentration of 8.0 to 20% (v/v) without using any special means. According to the present invention, in a method for producing a soy sauce, a carbohydrate raw material and water or an aqueous common salt solution are added to a first moromi, in which the viable soy sauce yeast cell count per 1 g of moromi is 1×10⁷ cells or more, followed by fermentation to prepare a second moromi having a common salt concentration of 4.0 to 12.0% (w/v) and an ethanol concentration of 4.0 to 12.0% (v/v), and then, a carbohydrate raw material and water or an aqueous common salt solution are added thereto to prepare a third moromi, in which the viable yeast cell count per 1 g of moromi is 2×10⁶ cells or more, and which has an ethanol concentration of 2.0% (v/v) or more, by further adding yeast or without adding yeast, followed by fermentation and maturation, thereby obtaining the very low common salt soy sauce.

### TECHNICAL FIELD

The present invention relates to a very low common salt (common salt 1.0 to 4.0% (w/v)) soy sauce containing a flavor component favorable for a soy sauce at a high concentration and being free of a spoiled soy sauce flavor without using a special means. The present invention also relates to a very low common salt soy sauce having, despite being very low common salt (a common salt concentration 1.0 to 4.0%), a total nitrogen concentration of 0.2 to 3.0% (w/v), and in which an ethanol concentration is 8.0 to 20.0% (v/v), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, and an isoamyl alcohol concentration per 1.0% (w/v) of a total nitrogen is 15.0 μg/ml or more, and being free of unpleasant tastes such as bitter taste, astringent taste, and acid taste.

### BACKGROUND ART

Soy sauce is produced by mixing steam-boiled soybeans and roasted and milled wheat, inoculating a seed kodi mold for soy sauce into this mixture and culturing to prepare a soy sauce koji, adding a common salt solution thereto to prepare a moromi so that the mature moromi contains common salt at 15 to 20% (w/v), fermenting for a predetermined period of time, maturing to prepare a mature moromi, and finally compressing, filtering, pasteurizing (sterilizing) and clarifying.

The thus obtained soy sauce contains, in addition to protein-derived amino acids and peptides as the effective components, saccharides, organic acids, alcohols, and small amounts of other components, and the like. Thus, a soy sauce is a versatile seasoning used for various cuisines including, needless to say, Japanese dish, Chinese dish, Western dish, and the like, however, it poses a drawback of containing common salt at 15 to 20% (w/v).

Due to the increasing health consciousness of the recent years, the preference to the low-salt food has been growing and, for the soy sauce likewise, those with a very low common salt concentration are anticipated. However, since common salt at 15 to 20% (w/v) plays the major role of preventing spoilage of the moromi during the process of fermenting and maturing the soy sauce moromi and is thus essential, it is commonly considered to be difficult to prepare a soy sauce moromi having a common salt concentration lower than 15% (w/v) unless a special technique is employed, and hence is not industrially carried out. More specifically, since the soy sauce moromi contains a large amount of proteins and starch, bacteria proliferate very easily, and spoilage bacteria also easily invade because the fermentation and maturation are controlled in the open or semi-hermetic condition. The bacteria, which once invade, quickly proliferate whereby the moromi is putrefied (spoiled) and lactic acid bacterium, acetic acid bacteria, and the like, proliferate abnormally, causing a risk of deteriorating flavors of the final product.

Conventionally, some methods for fermenting and maturing the soy sauce moromi under the condition of a substantially no or no salt content. However, all the methods pose problems or drawbacks, and are not considered to be sufficiently satisfactory methods.

For example, a method for producing a salt free soy sauce where the start of production is carried out using potassium a chloride water in place of an aqueous common salt solution has problems in that potassium chloride has the distinctive harsh taste, hyperkalemia may be caused when consumed in a large amount at one time by a renal failure patient, the issues of validity in calling the soy sauce which uses potassium chloride salt free, and the like.

Alternatively, a method where the start of production is carried out using a pure soy sauce in place of an aqueous common salt solution to produce a thick soy sauce, which is then diluted with water in the end, poses a drawback in that the deteriorated soy sauce taste and flavor are inevitable.

Also, in a method for producing a salt free soy sauce where the start of production is carried out using a brewer's alcohol in place of an aqueous common salt solution so that the moromi contains 5 to 20% (v/v) of an alcohol and the obtained soy sauce moromi is matured at 20° C. or less for 1 to 2 months (e.g., see Patent Document 1), the yeast fermentation is inhibited by the high alcohol concentration, failing to obtain a soy sauce with favorable flavor. Further, the method additionally requires a brewer's alcohol and causes a high cost, hence problematic. Furthermore, to use as a salt free soy sauce-like seasoning, the addition of saccharides and amino acids, and further the addition of a common salt-containing soy sauce, and the like, are essential, thereby having a problem.

A method where a soy sauce moromi is fermented and matured with heating to, for example, a moromi temperature of 40° C. or more (55° C. in an extreme example), which is a unsuitable condition under which the spoilage bacteria causing the moromi to decay proliferate and survive, results in fairly dark luster and color and warmed brewing smell or burnt smell due to the heating.

Further, a method where an acid such as hydrochloric acid, acetic acid or lactic acid is added to a soy sauce moromi to maintain the pH thereof to be 4.0 or less (3.0 in an extreme example) can prevent the spoilage since the proliferation of bacteria is significantly inhibited but has a problem of imparting an intense acid taste to the product (see Non-Patent Document 1).

Furthermore, a method for producing an alcohol-containing seasoning, in which one or more starch raw materials such as rice, cakes of mirin (sweet cooking rice wine), or the like, and rice koji for liquor brewing or (and) a starch hydrolase are mixed together with lactic acid and, if necessary, common salt into kunimizu water for preparation, a yeast is added thereto, 5 to 40% (v/v) of a soy sauce moromi with respect to the above kumimizu water is added, and then the mixture is subjected to saccharification, fermentation and maturation (e.g., see Patent Document 2), must maintain the pH at 4.5 or less, preferably 3.5 to 4.2, by adding lactic acid to the moromi to preserve the moromi during maturation (spoilage prevention) and has a drawback of causing the product to have an intense acid taste.

On the other hand, it is known that a reduced salt seasoning that has been desalinated using a reverse osmosis membrane or the like develops unpleasant tastes such as bitter taste, astringent taste, acid taste, or the like, when a common salt concentration is reduced to less than about 7% and a salt free soy sauce alike has unpleasant tastes, hence problematic (see Patent Document 1).

Thus, the conventional salt free and very low common salt soy sauces have drawbacks of having unpleasant tastes such as bitter taste, astringent taste, acid taste, or the like, and the methods for producing them also have drawbacks in that the deteriorated soy sauce flavor is inevitable as a result of employing a special means.

### PRIOR ART DOCUMENTS

### Patent Documents

Patent document 1: JP Patent Publication (Kokai) No. 2007-181450 A
Patent document 2: JP Patent Publication (Kokoku) No. 52-30599 B (1977)

### Non-Patent Document

Non-Patent Document 1: The Shoyu Sosho, the 1st series, written by Ichiro Nagase, Tokyo University of Agriculture, Brewing and Fermaentation, published on Jun. 1, 1967, pp 27 to 36

### SUMMARY OF THE INVENTION

### Problem to be Solved by the Invention

The present invention has an object to obtain, without using a special means, a very low common salt (common salt 1.0 to 4.0% (w/v)) soy sauce having a high concentration of a flavor component favorable for a soy sauce, and being free of a spoiled soy sauce flavor. Also, the present invention has an object to obtain a very low common salt soy sauce having, despite a very low common salt concentration (a common salt concentration 1.0 to 4.0% (w/v)), a total nitrogen concentration of 0.2 to 3.0% (w/v), and in which an ethanol concentration is 8.0 to 20.0% (v/v), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, and an isoanyl alcohol concentration per 1.0% (w/v) of a total nitrogen is 15.0 μg/ml or more, and being free of unpleasant tastes such as bitter taste, astringent taste, acid taste, or the like.

### Means for Solving Problem

The present inventors conducted extensive studies to solve these problems and, in the method for producing a soy sauce, (1) first prepared a first moromi having a viable soy sauce yeast cell count of 1×10⁷ cells or more per 1 g of the moromi, (2) consequently added a carbohydrate raw material and water thereto and fermented to prepare a second moromi having a common salt concentration of 4.0 to 12.0% (w/v) and an ethanol concentration of 4.0 to 12.0% (v/v), and (3) then added a carbohydrate raw material and water thereto, further adding or not adding a yeast to prepare a third moromi having a viable yeast cell count of 2×10⁶ cells or more per 1 g of the moromi and an ethanol concentration of 2% (v/v) or more. As a result, the present inventors found that the third moromi is not spoiled during the subsequent fermentation or maturation even when a common salt concentration is reduced to as very low as 1.0 to 4.0% (w/v), thereby obtaining a very low common salt soy sauce having a favorable flavor.

Further, the present inventors found that a very low common salt soy sauce having a common salt concentration of 1.0 to 4.0% (w/v) and a total nitrogen concentration of 0.2 to 3.0% (w/v), and in which an ethanol concentration is 8.0 to 20.0% (v/v), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, and an isoamyl alcohol concentration per 1.0% (w/v) of a total nitrogen is 15.0 μg/ml or more, is obtained. Also, in addition to the above, the present inventors found that a very low common salt soy sauce further containing a succinic acid concentration per 1.0% (w/v) of a total nitrogen of 500 μg/ml or more is obtained. Further, the present inventors found that the yeast added to the second moromi is preferably a yeast belonging to Saccharomyces cerevisiae, Zygosaccharomnrces rouxii, Torulopsis versatilis, or Torulopsis etchellsii.

More specifically, the present invention provides a very low common salt soy sauce having a favorable flavor and a method for producing the same as described below.

(1) A very low common salt soy sauce, which has a common salt concentration of 1.0 to 4.0% (w/v) and a total nitrogen concentration of 0.2 to 3.0% (w/v), and in which an ethanol concentration is 8.0 to 20.0% (v/v), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, and an isoamyl alcohol concentration per 1.0% (w/v) of a total nitrogen is 15.0 μg/ml or more.

(2) The very low common salt soy sauce according to (1), wherein the succinic acid concentration per 1.0% (w/v) of a total nitrogen is 500 μg/ml or more.

(3) A method for producing a very low common salt soy sauce, which comprises, in the method for producing a soy sauce, adding a carbohydrate raw material and water or an aqueous common salt solution to a first moromi having a viable soy sauce yeast cell count of 1×10⁷ cells or more per 1 g of the moromi and fermenting to prepare a second moromi having a common salt concentration of 4.0 to 12.0% (w/v) and an ethanol concentration of 4.0 to 12.0% (v/v), subsequently adding a carbohydrate raw material and water or a common salt solution to the second moromi, further adding or not adding a yeast to prepare a third moromi having a viable yeast cell count of 2×10⁶ cells or more per 1 g of the moromi and an ethanol concentration of 2.0% (v/v) or more, fermenting and maturing the third moromi to obtain a soy sauce having a common salt concentration of 1.0 to 4.0% (w/v), a total nitrogen concentration of 0.2 to 3.0% (w/v) and an ethanol concentration of 8.0 to 20.0% (v/v).

(4) The method for producing a very low common salt soy sauce according to (3), wherein the third moromi is prepared by adding a carbohydrate raw material and water or an aqueous common salt solution to the second moromi and further adding a yeast, and the yeast added to the second moromi is a yeast belonging to Saccharomnyces cerevisiae, Zygosaccharomyces rouxii, Torulopsis versatilis, or Torulopsis etchellsii.

(5) The method for producing a very low common salt soy sauce according to (3), wherein the carbohydrate raw material is any of the following 1) to 4).

1) At least one member selected from the group consisting of glucose, maltose, fructose, a hydrochloric-acid-hydrolyzed starch liquid, an enzymatically saceharified starch liquid, and starch-rich soy sauce koji prepared with the use of raw materials comprising starch raw materials accounting for more than 65% (w/w) of the raw materials and protein raw materials accounting for the remaining proportion thereof, rice koji, mugi koji, maize koji, and bran koji.

2) A combination of: carbohydrate raw material A which is at least one member selected from the group consisting of glucose, maltose, fructose, a hydrochloric-acid-hydrolyzed starch liquid, an enzymatically saccharified starch liquid, sucrose, a gelatinized cereal and a gelatinized root or tuber crop; and koji B which is at least one member selected from the group consisting of soy sauce koji, rice koji, mugi koji, maize koji and bran koji.

3) A combination of the carbohydrate raw material A; protein raw material which is at least one member selected from the group consisting of soybeans, defatted soybeans, wheat gluten and corn gluten; and the koji B.

4) A combination of the starch-rich soy sauce koji and the protein raw material.

The present specification encompasses the contents described in the specification of Japanese Patent Application No. 2011-064852, which is the basis of priority of the present application.

### Effects of the Invention

According to the present invention, a very low common salt (common salt 1.0 to 4.0% (w/v)) soy sauce containing a flavor component favorable for a soy sauce at a high concentration, and being free of a spoiled soy sauce flavor is obtained without using a special means. Also, the very low common salt soy sauce having, despite having a very low common salt concentration (a common salt concentration 1.0 to 4.0%), a total nitrogen concentration of 0.2 to 3.0% (w/v), and in which an ethanol concentration is 8.0 to 20.0% (v/v), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, and an isoamyl alcohol concentration per 1.0% (w/v) of a total nitrogen is 15.0 μg/ml or more, and being free of unpleasant tastes such as bitter taste, astringent taste, acid taste, and the like, is obtained.

### EMBODIMENTS FOR CARRYING OUT THE INVENTION

Hereinbelow, the very low common salt soy sauce and the method for producing the same of the present invention are described in detail.

### (Preparation of the First Moromi)

To carry out the present invention, in a soy sauce production method comprising adding soy sauce koji to an aqueous common salt solution and controlling the moromi temperature at 15° C. to 30° C. for approximately 3 to 8 months, the following (1) or (2) is used as a first moromi: (1) moromi in which the viable soy sauce yeast cell count per 1 g of moromi has reached 1×10⁷ cells or more and, in particular, 3×10⁷ cells to 3×10⁸ cells after the elapse of approximately a half month to 3 months from the date of start of production; or (2) moromi in which the viable soy sauce yeast cell count per 1 g of moromi has reached 1×10⁷ cells or more due to the addition of a soy sauce yeast culture liquid separately obtained via culture to soy sauce moromi before or during alcohol fermentation.

A soy sauce koji used in a usual process for producing a brewed soy sauce can be used.

A soy sauce koji can be prepared in the following manner. Steam-boiled and denatured protein raw materials such as soybeans and defatted soybeans and heat-denatured starch raw materials such as mugis (the term “mugi” or “mugis” used in the present invention refers to at least one grain selected from wheat, barley, oat, oat, and Job's tears) and rices are mixed. The moisture content of the mixture is adjusted to 35% to 45% (w/w). Then, seed koji molds such as Aspergillus sojae and Aspergillus oryzae are inoculated therein, and cultured at 20° C. to 40° C. for 1.5 to 4 days. The heat denaturation of mugis and rices is preferably performed by roasting and milling.

A soy sauce moromi is prepared by mixing a soy sauce koji and an aqueous common salt solution. The amount of the aqueous common salt solution is not particularly limited. However, in general, it is preferable to prepare a soy sauce moromi with the addition of an aqueous common salt solution at an amount that accounts for 100% to 450% (v/v) of the volume of plant seeds such as soybeans or wheat grains used for preparation of soy sauce koji (in terms of the fresh raw seed volume). According to the present invention, “the plant seed volume” refers to “bulk volume” including voids when measurement is carried out using a graduated cylinder or the like. An aqueous common salt solution is mixed with a soy sauce koji so that the common salt concentration in moromi prior to the addition of carbohydrate raw materials is equivalent to the common salt concentration in soy sauce moromi defined according to a general soy sauce production method, and such concentration is typically 15.0 to 20.0% (w/v).

It is important to add carbohydrate raw materials at the time when the viable soy sauce yeast cell count per 1 g of moromi has reached 1×10⁷ cells or more (the moromi at this stage is referred to as the first moromi in the present invention). If carbohydrate raw materials are added when the viable cell count is below this level, active alcohol fermentation cannot be expected to take place, resulting in a disadvantageous increase in the risk of spoilage of moromi.

### (Addition of Carbohydrate Raw Material and Water)

In addition, the carbohydrate raw materials are added to moromi in which the viable soy sauce yeast cell count per 1 g of moromi has reached 1×10⁷ cells or more and then water or an aqueous common salt solution is added thereto so as to adjust the common salt concentration in the moromi in a manner such that the common salt concentration in moromi juice after maturation is 4.0 to 12.0% (w/v). If the concentration is less than 4.0% (w/v), there is a disadvantageous risk of spoilage of soy sauce moromi. On the other hand, if it is more than 12.0% (w/v), it is difficult to produce and accumulate a high concentration of alcohols in the moromi and the ethanol concentration becomes insufficient after the third moromi is prepared, hence not preferable.

The major feature of the present invention is that the moromi never becomes spoiled even when water is added to dilute so that the common salt concentration in the second moromi juice at the fermentation stage is 4.0 to 12.0% (w/v) and the common salt concentration in the third moromi juice at the fermentation stage is 1.0 to 4.0% (w/v).

Specifically, according to a conventional soy sauce production method, soy sauce koji and an aqueous common salt solution are mixed (at the start of production) in an open system, and then the obtained moromi is fermented ad and matured in an open system. However, moromi is rich in nutritional sources appropriate for spoilage bacteria. Therefore, a decrease in the common salt concentration below a certain level causes active proliferation of spoilage bacteria. This results in the obvious manifestation of sour odor or taste, eventually leading to spoilage and strongly unpleasant odors.

Given that summer temperatures (i.e. 25° C. to 35° C.) fall within the optimal temperature range for the proliferation of so-called spoilage bacteria, there is no risk of spoilage when the common salt concentration in moromi is above a certain level; that is to say, when the concentration is 15% (w/v) or more. However, when the concentration is below such level, spoilage takes place in a relatively short period of time. Therefore, it is necessary to adjust the common salt concentration to the above level or higher based on the assumption that if the safe level of the common salt concentration in moromi in the summertime is 17% (w/v), the dangerous level thereof is 16% (w/v) or less. In view of the above, it is said that there is a risk of inhibition of smooth fermentation and maturation if the common salt concentration is less than 15% (w/v), even in an environment in which comprehensive measures for management of contamination with and proliferation of spoilage bacteria have been implemented.

Under the above circumstances, according to the present invention, even when the common salt concentration in the second moromi juice at the fermentation stage is adjusted to be 4.0 to 12.0% (w/v) and the common salt concentration in the third moromi juice at the fermentation stage is adjusted to be 1.0 to 4.0% (w/v), it is possible to surely prevent proliferation of spoilage bacteria without keeping the moromi temperature at 40° C. or higher (55° C. in an extreme case) by heating or maintaining the pH at 4.0 or less (3.0 or less in an extreme case) by adding an acid such as hydrochloric acid or lactic acid to moromi.

Examples of carbohydrate raw materials include: (I) glucose (e.g., crystal glucose, power glucose, or liquid glucose), maltose, fructose, sucrose, a gelatinized cereal (e.g., a mugi or rice), and a gelatinized root or tuber crop; (II) a saccharified liquid of starch raw material obtained via hydrochloric acid hydrolysis; (III) a saccharified liquid of starch obtained via enzymatic degradation; (IV) “starch-rich soy sauce koji” obtained by a conventional method for preparing soy sauce koji with the use of raw materials comprising starch raw materials (e.g., wheat, barley, rye, Job's tears, rice, and maize) accounting for more than 65% (w/w) of the raw materials and protein raw materials (e.g., soybeans and gluten) accounting for the remaining proportion thereof rice kgji obtained using low-quality rice such as milled Japanese rice or milled non-Japanese rice or rice preferable for sake, mugi koji, maize koji, and bran koji; and (V) saccharified koji from any of the above examples (e.g., amazake (traditional sweet drink made from fermented rice) or liquid of digested koji). These carbohydrate raw materials can be used alone or in combination. In the present invention, “mugi koji” refers to koji prepared by using at least one raw material selected from wheat, barley, rye, and Job's tears, and typically mugi koji prepared by barley or wheat, such as barley koji, wheat koji.

In the present invention, the above carbohydrate raw materials are grouped as described below, and relevant terms are individually defined below.

(1) The term “carbohydrate raw material A” refers to at least one member selected from the group consisting of glucose, maltose, fructose, a hydrochloric-acid-hydrolyzed starch liquid, an enzymatically saccharified starch liquid, sucrose, a gelatinized cereal, and a gelatinized root or tuber crop.

(2) The term “koji B” used herein refers to at least one member selected from the group consisting of soy sauce koji, rice koji, mugi koji, maize koji, and bran koji. Soy sauce koji also includes “starch-rich soy sauce koji” defined below.

(3) The term “starch-rich koji” refers to “starch-rich soy sauce koji” obtained by preparing soy sauce koji by a conventional method with the use of raw materials comprising starch raw materials such as wheat, barley, rye, Job's tears, rice, and maize accounting for more than 65% (w/w) of the raw materials and protein raw materials such as soybeans or defatted soybeans accounting for the remaining proportion thereof, rice koji obtained from low quality rice such as milled Japanese rice or milled non-Japanese rice or rice preferable for production of sake or, mugi koji, maize koji, and bran koji.

(4) The term “protein raw material” refers to at least one member selected from the group consisting of soybeans, defatted soybeans, wheat gluten, and corn gluten.

When the above carbohydrate raw materials are used in combination, preferable examples of a combination thereof include: 1) a combination of carbohydrate raw material A and koji; 2) a combination of carbohydrate raw material A, a protein raw material, and koji; and 3) a combination of starch-rich koji and a protein raw material.

An example of a saccharified liquid of starch raw material obtained via hydrochloric acid hydrolysis in (II) above is a liquid obtained by adding diluted hydrochloric acid (e.g., diluted hydrochloric acid (approximately 2 to 3% (v/v)) to a starch raw material such as wheat powder, milled rice, white bran, milled mugi grain, or maize such that the weight ratio of diluted hydrochloric acid to a starch raw material is approximately 2:1 to 4:1, heating the mixture at approximately 100° C. by a steam injection method or the like for 3 to 4 hours, and neutralizing the resultant to pH 5.0 to 6.0 using sodium carbonate, followed by filtration.

An example of a saccharified liquid of starch obtained via enzymatic degradation in (III) above is a liquid obtained by adding 1 to 3 parts by weight of an aqueous common salt solution (10 to 15% (w/v)) to 1 part by weight of starch-rich koji and heating the mixture at 50° C. to 60° C. for 5 to 20 hours so as to saccharify starch in koji.

Another example thereof is a liquid obtained by gelatinizing an aqueous starch suspension by heating, adding starch-rich koji or bran koji thereto to cause koji amylase to saccharify starch, and thereby degrading the starch into maltose and glucose.

Further, sucrose, a gelatinized cerial, or a gelatinized root or tuber crop added to moromi is saccharified by a saccharifying enzyme contained in soy sauce moromi. However, the level of amylase activity in soy sauce moromi falls far below the initial level by at least approximately a half month after the start of production, which is insufficient for saccharification. Therefore, it is preferable to add the above raw materials in combination with soy sauce koji, bran koji, rice koji, and/or mugi koji. By doing so, sucrose, a gelatinized cereal, or a gelatinized root or tuber crop can be quickly saccharified into glucose by amylase contained in newly added koji in moromi.

Moreover, protein raw materials added to moromi are hydrolyzed by protease or the like contained in soy sauce moromi. However, the level of protease activity in soy sauce moromi falls far below the initial level by at least approximately a half month after the start of production, which is insufficient for saccharification. Therefore, it is preferable to add the above raw materials in combination with soy sauce koji, bran koji, rice koji, and/or mugi koji. By doing so, protein raw materials can be degraded to amino acids and the like by protease or the like contained in newly added koji in moromi.

It is necessary to add carbohydrate raw materials in such an amount that the ethanol concentration in the second moromi juice after the fermentation would be 4.0% or more, preferably 8.0 to 12.0% (v/v).

Then, the moromi obtained above is kept at 15° C. to 35° C. in accordance with a general method and subjected to agitation or aeration 1 to several times a day or subjected to agitation by means of compressed air, a propeller-type revolving agitator, or the like in an adequate manner so as to induce alcohol fermentation. Alternatively, it may be subjected to continuous agitation with aeration.

In the above moromi, alcohol fermentation is extremely vigorous. As a result, ethanol is quickly produced, thereby providing the second moromi having a common salt concentration of 4.0 to 12.0% (w/v) and an ethanol concentration of 4.0 to 12.0% (v/v).

### (Preparation of the Third Moromi)

Next, a carbohydrate raw material and water or an aqueous common salt solution are added to the second moromi to prepare the third moromi.

At this time, there is no need to newly add any yeast when the third moromi contains a viable yeast cell count of 2×10⁶ cells or more per 1 g of the moromi. However, when the viable yeast cell count is low, the moromi is likely to be spoiled during the subsequent fermentation, and hence a yeast must be added. The yeast used herein is preferably those belonging to Saccharornyces cerevisiae, Zygosaccharomnyces rouxii, Torulopsis versatilis, or Torulopsis etchellsii.

It is also very important to adjust the initial ethanol concentration in the third moromi to be 2% (v/v) or more, since the concentration less than that causes a risk of spoilage of the moromi during the subsequent fermentation, hence not preferable.

The water or aqueous common salt solution added to the second moromi (or the first moromi) is required to be adjusted so that the common salt concentration in the soy sauce moromi obtained by maturing the third moromi is 1.0 to 4.0% (w/v).

The carbohydrate raw materials described above are also usable as the carbohydrate raw material added to the second moromi. Further, it is essential to add so that the total nitrogen in the mature moromi obtained by maturing the third moromi is 0.2 to 3.0% (w/v). When the concentration is less than 0.2% (w/v), there is a drawback of missing umami savory taste, whereas the concentration is higher than 3.0% (w/v), the alcohol production and accumulation by the yeast are reduced, hence not preferable.

Then, the third moromi obtained in the above is suitably aerated and agitated, fermented and matured at a moromi temperature of 15 to 30° C. for about half a month to 3 months, compressed, filtered, pasteurized and clarified to obtain the very low common salt soy sauce of the present invention.

The soy sauce of the present invention, despite being very low common salt, has the feature of being the very low common salt soy sauce having a total nitrogen concentration of 0.2 to 3.0% (w/v), and in which an ethanol concentration is 8.0 to 20.0% (v/v), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, and an isoamyl alcohol concentration per 1.0% (w/v) of a total nitrogen is 15.0 μg/ml or more, and free of unpleasant tastes such as bitter taste, astringent taste, bitter taste, and the like. Further, the soy sauce of the present invention also has the feature of having a succinic acid concentration per 1.0% (w/v) of a total nitrogen of 500 μg/ml or more.

The upper limits in the concentrations of 2-phenylethanol, isobutyl alcohol, isoamyl alcohol and succinic acid, per 1.0% (w/v) of a total nitrogen, in the very low common salt soy sauce of the present invention are not particularly limited, but typically, 600 μg/ml or less of 2-phenylethanol, 800 g/ml or less of isobutyl alcohol, 1600 μg/ml or less of isoamyl alcohol, and 6000 μg/ml or less of succinic acid, respectively.

Further, the very low common salt soy sauce (soy sauce moromi juice) obtained by the present invention substantially has the common component analysis as shown below.

TN (total nitrogen): 0.2 to 3.0% (w/v)

NaCl (common salt): 1.0 to 4.0% (w/v)

Alc. (ethanol): 8.0 to 20% (v/v)

RS (reducing sugar): 0 to 14.0% (w/v)

Lac. (lactic acid): 0.05 to 0.20% (w/v)

Glu. (glutamic acid): 0.03 to 3.5% (w/v)

pH: 4.6 to 5.5

Col. (Japan soy sauce standard color): 35 to 58

The very low common salt soy sauce obtained in the above may be dried and powdered as necessary to use as a powder seasoning.

Examples of the method for drying and powdering include a method where an excipient such as dextrin, or the like, is added to the soy sauce, dissolved with heating, and subjected to drying and powdering such as a spray-dry method, drum-dry method, freeze-dry method, or the like.

With reference to Preliminary Tests 1 to 7 below, in the method for producing the soy sauce, the steps for preparing the first moromi having a viable soy sauce yeast cell count of 1×10⁷ cells or more per 1 g of the moromi, adding a carbohydrate raw material and water thereto for the fermentation to prepare the second moromi having a common salt concentration of 4.0 to 12.0% (w/v) and an ethanol concentration of 4.0 to 12.0% (v/v) are described more specifically.

Further, with reference to Examples 1 to 3, specifically described is the obtention of the very low common salt soy sauce of the present invention by adding a carbohydrate raw material and water to the second moromi to prepare the third moromi containing a viable yeast cell count of 2×10⁶ cells or more per 1 g of the moromi and an ethanol concentration of 2.0% (v/v) or more, and fermenting and maturing the obtained moromi.

### <Preliminary Test 1>

### (1) Preparation of a Soy Sauce Koji

Warm water (80° C.) was added to defatted soybeans (10 kg) (130% (w/w)). The mixture was heated and steam-boiled under pressure using saturated water vapor at a steam pressure of 2 kg/cm² (gauge pressure) for 20 minutes. In addition, raw wheat (10 kg) was roasted and milled by a conventional method. Next, the two processed raw materials were mixed to prepare a koji-making raw material with a moisture content of approximately 40% (w/w).

Next, this koji-making raw material was inoculated with a bran seed koji mold of Aspergillus oryzac (ATCC14895) (effective spore count: 1×10⁹ spores/g) at 0.1% (w/w), which was then heaped in a container for koji-making (koji-buta). The container was subjected to a usual koji-making process for 42 hours to obtain a soy sauce koji.

### (2) Preparation of Soy Sauce Moromi

The above soy sauce koji (0.8 kg) was mixed with a 18% (w/v) aqueous common salt solution (1.9 L). Next, a soy sauce lactic acid bacterium was added to the soy sauce moromi so that the cell count would be 1×10⁵ cells per 1 g of moromi. Decomposition, elution, and lactic acid fermentation of raw materials with a soy sauce koji enzyme were carried out while keeping the moromi temperature at 15° C. for 1 month. Thus, soy sauce moromi (common salt concentration: approximately 15% (w/v)) preferable for soy sauce yeast proliferation was obtained.

About 3 kg of the obtained soy sauce moromi was prepared for 4 groups (Reference Examples 1 and 2 and Comparative Examples 1 and 2), a soy sauce yeast (Zygosaccharomyces rouxii) was added to each group so as to give 5×10⁵ cells per 1 g of the moromi, a moromi temperature was maintained at 20° C., the moromi was aerated and agitated to prepare the first moromi having the viable soy sauce yeast cell count per 1 g of the moromi of the values shown in Table 1.

### (3) Addition of Carbohydrate Raw Material and Adjustment of Common Salt Concentration

Then, the soy sauce koji (1.6 kg) described in (1) above and hydrated crystal glucose (Showa Sangyo Co., Ltd.) (0.35 kg) were added to the first moromi of each group obtained above. Further, water (1.7 L) was added thereto so that the common salt concentration in mature moromi juice would be 6.5% (w/v). The resultant is used as the pre-matured second moromi.

### (4) Maturation

Thereafter, agitation was adequately performed for maturation, during which the moromi temperature was kept at 25° C. Four months after the start of production, the moromi samples were pressed to obtain raw soy sauce samples, followed by pasteurisation and clarification. Thus, four different low common salt soy sauce samples were obtained. The obtained low common salt soy sauce samples were subjected to component analysis and sensory evaluation. Table 1 shows component analysis results. Table 2 shows sensory evaluation results.

### (Component Analysis)

The common salt concentration, the ethanol concentration, the total nitrogen concentration, and pH were determined in accordance with the methods described in “Experimental Method for Soy Sauce” edited by the Japan Soy Sauce Inspection Institute (issued on Mar. 1, 1985).

In addition, the succinic acid and glucose concentrations were determined by high-performance liquid chromatography analysis.

### (Analysis of Alcohols)

The concentrations of 2-phenyl ethanol, isobutyl alcohol, and isoamyl alcohol were determined by the quantitative analysis method using gas chromatography as described in the Journal of Agricultural and Food Chemistry Vol. 39, 934, 1991.

### (Sensory Evaluation)

Sensory evaluation was performed by 20 panelists who had been trained to have the ability to discriminate among samples using a grading system. Specifically, the low common salt soy sauce samples were compared with a commercially available reduced common salt soy sauce (Kikkoman Corporation) based on the following scales: Not different: 0; Slightly different: 1; Different: 2; Somewhat obviously different: 3; Obviously different: 4; and Significantly different: 5. If a sample was found to have a flavor superior to that of the commercially available reduced common salt soy sauce, the sample was marked with (+). On the other hand, if a sample was found to have a flavor inferior to that of the same, the sample was marked with (−).

In addition, the grades in the Table are the average values of the 20 panelists, and the symbol “**,” “*,” and “-” used in the Evaluation columns refer to “significant at the 1% level of significance,” “significant at the 5% level of significance,” and “Not significant,” respectively.

### (Measurement of Viable Yeast Cell Count)

The viable yeast cell count was measured in accordance with the method described in “Food Microbiology Handbook” (edited by Hisao Yoshii, Yasuyuki Kaneko, and Kazuo Yamaguchi, Gihodo Shuppan Co., Ltd., p. 603).

TABLE 1

| | Viable soy sauce yeast | | Low common salt soy sauce | | |
|---|---|---|---|---|---|
| | cell count per 1 g of | Common salt | component analysis values | | |
| | moromi upon addition | concentration | Ethanol | Total nitrogen | |
| | of carbohydrate raw | in mature moromi | concentration | concentration | |
| Group | material (cells) | juice ## (% (w/v)) | (% (w/v)) | (% (w/v)) | pH |
| Reference Example 1 | 1 × 10⁷ | 6.5 | 6.5 | 1.7 | 5.0 |
| Reference Example 2 | 3 × 10⁷ | 6.5 | 6.8 | 1.7 | 5.2 |
| Comparative Example 1 | 1 × 10⁶ | 6.5 | # | # | # |
| Comparative Example 2 | 5 × 10⁶ | 6.5 | 5.2 | 1.7 | 4.5 |
| Commercially-available | | 8.4 | 5.5 | 1.9 | 4.7 |
| reduced salt soy sauce | | | | | |

# Spoilage took place and thus moromi was not subjected to component analysis in this case.
## Moromi juice means the juice obtained by separating and removing the solid content from the soy sauce moromi using filter paper filtration, or the like.

TABLE 2

| | Viable soy sauce yeast | | | |
|---|---|---|---|---|
| | cell count per 1 g | | | |
| | of moromi upon addition | | | |
| | of carbohydrate | Sensory Evaluation | | |
| Group | raw material (cells) | Average grade | Evaluation | Remarks |
| Reference Example 1 | 1 × 10⁷ | +2.8 | ** | Favorable flavor |
| Reference Example 2 | 3 × 10⁷ | +4.0 | ** | Favorable flavor |
| Comparative Example 1 | 1 × 10⁶ | # | # | Spoiled |
| Comparative Example 2 | 5 × 10⁶ | −1.6 | ** | Slightly acidic taste and smell |

# Spoilage took place and thus moromi was not subjected to sensory evaluation in this case.

Based on the results shown in Tables 1 and 2, it is understood that if the common salt concentration in mature moromi juice is adjusted to 6.5% (w/v), it would disadvantageously cause a low common salt soy sauce to become spoiled or have a sour taste or odor in cases in which carbohydrate raw materials are added to the first moromi within a period during which the viable soy sauce yeast cell count per 1 g of the first moromi is less than 1×10⁷ cells (e.g. 1×10⁶ cells (Comparative Example 1) or 5×10⁶ cells (Comparative Example 2))

Meanwhile, it is understood that even if the common salt concentration in mature moromi juice is adjusted to 6.5% (w/v), a low common salt soy sauce would not become spoiled in cases in which carbohydrate raw materials are added within a period during which the viable soy sauce yeast cell count per 1 g of the first moromi is 1×10′ cells or more (Reference Example 1 and Reference Example 2). A reduced common salt soy sauce having a favorable flavor can be obtained.

### <Preliminary Test 2>

A low common salt soy sauce was obtained in the manner described above except that the common salt concentration of moromi was adjusted by adding soy sauce koji and glucose as a carbohydrate raw material aerial at amounts listed in Table 3 and further adding water or an aqueous common salt solution at an amount listed in Table 3 to the aerated and agitated first moromi in the method for producing the low common salt soy sauce of Reference Example 2 (viable soy sauce yeast cell count per 1 g of moromi upon addition of carbohydrate raw material: 3×10⁷ cells) in Preliminary Test 1. Component analysis and sensory evaluation of the thus obtained low common salt soy sauce were carried out as in the case of Preliminary Test 1. Tables 4 to 6 show the results. Note that the common salt concentration of moromi is adjusted by changing the proportions of water and an aqueous common salt solution to be added depending on the desired final common salt concentration. This is because it is necessary to change the concentration depending on the moisture content of the koji, as well.

TABLE 3

| | Soy sauce | Glucose | Water and aqueous | Common salt concentration |
|---|---|---|---|---|
| Group | koji (kg) | (kg) | common salt solution (L) | in mature moromi juice (% (w/v)) |
| Comparative Example 3 | 4.0 | 2.00 | 11.0 | 2.0 |
| Reference Example 3 | 2.4 | 0.80 | 5.1 | 4.0 |
| Reference Example 2 | 1.6 | 0.35 | 1.7 | 6.5 |
| Reference Example 4 | 1.6 | 0.20 | 1.7 | 12.0 |
| Comparative Example 4 | 1.6 | 0 | 1.4 | 14.5 |

TABLE 4

| | | Low common salt soy sauce | | |
|---|---|---|---|---|
| | | component analysis values | | |
| | Common salt concentration in | Ethanol concentration | Total nitrogen | |
| Group | mature moromi juice (% (w/v)) | (% (v/v)) | concentration (% (w/v)) | pH |
| Comparative Example 3 | 2.0 | # | # | 4.1 |
| Reference Example 3 | 4.0 | 8.5 | 1.4 | 5.4 |
| Reference Example 2 | 6.5 | 6.8 | 1.7 | 5.2 |
| Reference Example 4 | 12.0 | 4.5 | 1.6 | 5.1 |
| Comparative Example 4 | 14.5 | 3.5 | 1.9 | 5.5 |

# Spoilage took place and thus moromi was not subjected to component analysis in this case.

TABLE 5

| | | Component concentration (μg/ml) | | | |
|---|---|---|---|---|---|
| | | per 1.0% (w/v) of total nitrogen concentration | | | |
| | Common salt concentration | | Isobutyl | Isoamyl | Succinic |
| Group | in mature moromi juice (% (w/v)) | 2-phenylethanol | alcohol | alcohol | acid |
| Comparative Example 3 | 2.0 | # | # | # | # |
| Reference Example 3 | 4.0 | 27.3 | 37.6 | 64.2 | 917 |
| Reference Example 2 | 6.5 | 18.6 | 14.5 | 27.4 | 836 |
| Reference Example 4 | 12.0 | 8.9 | 11.0 | 16.0 | 505 |
| Comparative Example 4 | 14.5 | 5.1 | 7.9 | 14.6 | 257 |
| Commercially-available | 8.4 | 4.5 | 8.2 | 7.6 | 250 |
| reduced salt soy sauce | | | | | |

# Spoilage took place and thus moromi was not subjected to component analysis in this case.

TABLE 6

| | Common salt concentration | Sensory Evaluation | | |
|---|---|---|---|---|
| Group | in mature moromi juice (% (w/v)) | Average grade | Evaluation | Remarks |
| Comparative Example 3 | 2.0 | # | # | Spoilage |
| Reference Example 3 | 4.0 | +4.5 | ** | Favorable flavor |
| Reference Example 2 | 6.5 | +4.0 | ** | Favorable flavor |
| Reference Example 4 | 12.0 | +1.8 | ** | Favorable flavor |
| Comparative Example 4 | 14.5 | +0.9 | — | Relatively favorable flavor |

# Spoilage took place and thus moromi was not subjected to sensory evaluation in this case.

Based on the results shown in Tables 4 to 6, it is understood that it is important to adjust the common salt concentration of the first moromi after the addition of carbohydrate raw materials to the first moromi so that the common salt concentration of mature moromi juice would be 4.0 to 12.0% (w/v) because when the common salt concentration of mature moromi juice is less than 4.0% (w/v) (Comparative Example 3), the moromi disadvantageously becomes spoiled as shown in Table 4.

On the other hand, it is also understood that when it exceeds 12.0% (w/v) (Comparative Example 4) as shown in Table 5, the concentrations of 2-phenyl ethanol, isobutyl alcohol, isoamyl alcohol and succinic acid decrease. Meanwhile, it is understood that a low common salt soy sauce having favorable flavor, in which the ethanol concentration is 4.0% (v/v) or more while the 2-phenyl ethanol concentration per 1.0% (w/v) of total nitrogen concentration is 7.0 μg/rnr or more, the isobutyl alcohol concentration per 1.0% (w/v) of total nitrogen concentration is 10.0 μg/ml or more, and the isoamyl alcohol concentration per 1.0% (w/v) of total nitrogen concentration is 15.0 μg/ml or more, and in which the succinic acid concentration per 1.0% (w/v) of total nitrogen concentration is 500 μg/ml or more, can be obtained when the common salt concentration of the moromi is adjusted in a manner such that moromi juice after maturation would be 4.0 to 12.0% (w/v) (Reference Example 2, Reference Example 3, and Reference Example 4).

### <Preliminary Test 3>

A low common salt soy sauce (Reference Example 5) was obtained in the manner described above except that soy sauce koji (1.4 kg) and roasted and milled wheat (0.35 kg) as a carbohydrate raw material were added to the aerated and agitated first moromi in the method for producing the low common salt soy sauce of Reference Example 2 (the viable soy sauce yeast cell count per 1 g of the first moromi upon addition of carbohydrate raw material: 3×10⁷ cells) in Preliminary Test 1.

The obtained low common salt soy sauce (Reference Example 5) was compared with Reference Example 2 obtained in Preliminary Test 1 (using glucose as a carbohydrate raw material). In addition, sensory evaluation was carried out as in the case of Preliminary Test 1 with the use of a commercially available reduced common salt soy sauce (Kikkoman Corporation) as a control. Tables 7 to 10 show the results.

TABLE 7

| | | Carbohydrate raw material | | Water and aqueous | Common salt concentration |
|---|---|---|---|---|---|
| | Soy sauce | Glucose | Roasted and | common salt | in mature moromi juice |
| Group | koji (kg) | (kg) | milled wheat (kg) | solution (L) | (% (w/v)) |
| Reference Example 2 | 1.6 | 0.35 | | 1.7 | 6.5 |
| Reference Example 5 | 1.4 | | 0.35 | 1.7 | 6.5 |

TABLE 8

| | Low common salt soy sauce component analysis values | | | |
|---|---|---|---|---|
| | Common salt | Ethanol | Total nitrogen | |
| Group | concentration (% (w/v)) | concentration (% (w/v)) | concentration (% (w/v)) | pH |
| Reference Example 2 | 6.5 | 6.8 | 1.7 | 5.2 |
| Reference Example 5 | 6.5 | 6.5 | 1.6 | 5.0 |

TABLE 9

| | Component concentration (μg/ml) per 1.0% | | | |
|---|---|---|---|---|
| | (w/v) of total nitrogen concentration | | | |
| | | Isobutyl | Isoamyl | Succinic |
| Group | 2-phenylethanol | alcohol | alcohol | acid |
| Reference Example 2 | 18.6 | 14.5 | 27.4 | 836 |
| Reference Example 5 | 7.6 | 14.9 | 21.5 | 520 |

TABLE 10

| | Sensory Evaluation | | |
|---|---|---|---|
| Group | Average grade | Evaluation | Remarks |
| Reference Example 2 | +4.0 | ** | Favorable flavor |
| Reference Example 5 | +3.5 | ** | Favorable flavor |

Based on the results shown in tables 7 to 10, it is understood that roasted and milled wheat, which is a gelatinized cereal, is rapidly saccharified by enzymes (e.g., amylase) from a newly added soy sauce koji in moromi to yield glucose, and glucose is assimilated by the soy sauce yeast, resulting in accumulation of ethanol, 2-phenyl ethanol, isobutyl alcohol, and isoamyl alcohol, which are known as important aromatic components of soy sauce, in soy sauce moromi at high concentrations. Thus, a low common salt soy sauce having a favorable flavor can be obtained without using special means.

### <Preliminary Test 4>

A low common salt soy sauce (Reference Example 6) was obtained in the above manner except that glucose (0.6 kg) was added to the aerated and agitated the first moromi as a carbohydrate raw material without the addition of soy sauce koji in the method for producing the low common salt soy sauce of Reference Example 2 (viable soy sauce yeast cell count per 1 g of moromi upon addition of a carbohydrate raw material: 3×10⁷ cells) in Preliminary Test 1, and at the same time, water and an aqueous common salt solution (1.1 L in total) were added so that the final common salt concentration in moromi would be 8%.

The obtained low common salt soy sauce (Reference Example 6) was compared with Reference Example 2 obtained in Preliminary Test 1. In addition, sensory evaluation was performed using a commercially available reduced common salt soy sauce (Kikkoman Corporation) as a control as in the case of Preliminary Test 1. Tables 11 to 14 show the results.

Based on the results shown in Tables 11 to 14, it is understood that a low common salt soy sauce having a favorable flavor, in which the concentration of ethanol known as an important aromatic component in soy sauce is 4.0% (v/v) or more while the 2-phenyl ethanol concentration per 1.0% (w/v) of total nitrogen concentration is 7.0 μg/ml or more, the isobutyl alcohol concentration per 1.0% (w/v) of total nitrogen concentration is 10.0 μg/ml or more, and the isoamyl alcohol concentration per 1.0% (w/v) of total nitrogen concentration is 15.0 μg/ml or more, and in which the succinic acid concentration per 1.0% (w/v) of total nitrogen concentration is 500 μg/ml or more, can be obtained as a result of assimilation of added glucose by soy sauce yeast.

Note that since glucose alone was added to the moromi without addition of soy sauce koji, the total nitrogen content significantly decreased. Therefore, the total nitrogen content was adjusted to the total nitrogen content for Reference Example 6 (0.7% (w/v)) for sensory evaluation.

TABLE 11

| | | | | Common salt |
|---|---|---|---|---|
| | | | Water | concentration |
| | | Carbohydrate | and aqueous | in mature |
| | Soy sauce | raw material | common salt | moromi |
| Group | koji (kg) | (glucose) (kg) | solution (L) | juice (% (w/v)) |
| Reference | 1.6 | 0.35 | 1.7 | 6.5 |
| Example 2 | | | | |
| Reference | 0 | 0.60 | 1.1 | 8.0 |
| Example 6 | | | | |

TABLE 12

| | Low common salt soy sauce component analysis values | | | |
|---|---|---|---|---|
| | Common salt | Ethanol | Total nitrogen | |
| | concentration | concentration | concentration | |
| Group | (% (w/v)) | (% (w/v)) | (% (w/v)) | PH |
| Reference | 6.5 | 6.8 | 1.7 | 5.2 |
| Example 2 | | | | |
| Reference | 8.0 | 8.9 | 0.7 | 4.7 |
| Example 6 | | | | |

TABLE 13

| | Component concentration (μg/ml) per 1.0% | | | |
|---|---|---|---|---|
| | (w/v) of total nitrogen concentration | | | |
| | | Isobutyl | Isoamyl | Succinic |
| Group | 2-phenylethanol | alcohol | alcohol | acid |
| Reference Example 2 | 18.6 | 14.5 | 27.4 | 836 |
| Reference Example 6 | 113.3 | 220.7 | 99.6 | 1643 |

TABLE 14

| | Sensory Evaluation | | |
|---|---|---|---|
| Group | Average grade | Evaluation | Remarks |
| Reference Example 2 | +4.0 | ** | Favorable flavor |
| Reference Example 6 | +2.6 | ** | Favorable flavor |

### <Preliminary Test 5>

(Production of Starch-Rich Koji)

Warm water (80° C.;) was added to defatted soybeans (6 kg) (130% (w/w)). The mixture was heated and steam-boiled under pressure using saturated water vapor at a steam pressure of 2 kg/cm² (gauge pressure) for 20 minutes. In addition, raw wheat (14 kg) was roasted and milled by a conventional method. Next, the two processed raw materials were mixed to prepare a raw material for koji production with a moisture content of approximately 40% (w/w).

Next, this koji-making raw material was inoculated with a bran seed koji mold of Aspergillus oryzae (ATCC14895) (effective spore count: 1×10⁹ spores/g) at 0.1% (w/w), which was then heaped in a container (koji-buta). The container was subjected to a usual koji-making process for 42 hours to obtain a starch-rich soy sauce koji with a wheat proportion of 70%.

Further, warm water (80° C.) was added to defatted soybeans (0.2 kg) (130% (w/w)). The mixture was heated and steam-boiled under pressure using saturated water vapor at a steam pressure of 2 kg/cm² (gauge pressure) for 20 minutes. In addition, raw wheat (19.8 kg) was roasted and milled by a conventional method. Next, the two processed raw materials were mixed to prepare a raw material for koji production with a moisture content of approximately 40% (w/w).

Next, this koji-making raw material was inoculated with a bran seed koji mold of Aspergillus oryzae (ATCC14895) (effective spore count: 1×10⁹ spores/g) at 0.1% (w/w), which was then heaped in a container (koji-buta). The container was subjected to a usual koji-making process for 42 hours to obtain a starch-rich soy sauce koji with a wheat proportion of 99%.

### (Preparation of Moromi)

Low common salt soy sauces (Reference Examples 7 and 8) were obtained in the above manner except that starch-rich koji prepared above was added as a carbohydrate raw material to the aerated and agitated first moromi described above at an amount shown in Table 15 without the addition of soy sauce koji in the method for producing the low common salt soy sauce of Reference Example 2 (viable soy sauce yeast cell count per 1 g of moromi upon addition of a carbohydrate raw material: 3×10⁷ cells) in Preliminary Test 1, and at the same time, water and an aqueous common salt solution (1.6 L in total) were added so that the final common salt concentration in moromi would be 7.0%.

TABLE 15

| | | Carbohydrate | | | |
|---|---|---|---|---|---|
| | | raw material | | | |
| | | | Starch-rich | Water and | Common salt concentration |
| | Soy sauce | | soy sauce | aqueous common | in mature moromi |
| Group | koji (kg) | Glucose | koji (kg) | salt solution (L) | juice (% (w/v)) |
| Reference Example 2 | 1.6 | 0.35 | | 1.7 | 6.5 |
| Reference Example 7 | | | 1.6 | 1.6 | 7.0 |
| Soybean:Wheat (30:70) | | | | | |
| Reference Example 8 | | | 1.6 | 1.6 | 7.0 |
| Soybean:Wheat (1:99) | | | | | |

The obtained low common salt soy sauces (Reference Examples 7 and 8) were compared with Reference Example 2 obtained in Preliminary Test 1 (using glucose as a carbohydrate raw material). In addition, sensory evaluation was performed using a commercially available reduced common salt soy sauce (Kikkoman Corporation) as a control as in the case of Preliminary Test 1. Tables 16 to 18 show the results.

Based on the results shown in Tables 16 to 18, it is understood that a low common salt soy sauce having a favorable flavor, in which the concentration of ethanol known as an important aromatic component in soy sauce is 4.0% (v/v) or more while the 2-phenyl ethanol concentration per 1.0% (w/v) of total nitrogen concentration is 7.0 μg/ml or more, the isobutyl alcohol concentration per 1.0% (w/v) of total nitrogen concentration is 10.0 μg/ml or more, and the isoamyl alcohol concentration per 1.0% (w/v) of total nitrogen concentration is 15.0 μg/ml or more, and in which the succinic acid concentration per 1.0% (w/v) of total nitrogen concentration is 500 μg/ml or more, can be obtained without using special means as a result of rapid decomposition of starch-rich soy sauce koji into glucose and assimilation of glucose by soy sauce yeast.

TABLE 16

| | Low common salt soy sauce | | | |
|---|---|---|---|---|
| | component analysis values | | | |
| | Common salt | Ethanol | Total nitrogen | |
| | concentration | concentration | concentration | |
| Group | (%(w/v)) | (%(v/v)) | (%(w/v)) | pH |
| Reference | 6.5 | 6.8 | 1.7 | 5.2 |
| Example 2 | | | | |
| Reference | 7.0 | 7.7 | 1.7 | 5.2 |
| Example 7 | | | | |
| Reference | 7.0 | 8.2 | 1.4 | 5.4 |
| Example 8 | | | | |

TABLE 17

| | Component concentration (μg/ml) per 1.0% (w/v) | | | |
|---|---|---|---|---|
| | of total nitrogen concentration | | | |
| | | Isobutyl | Isoamyl | Succinic |
| Group | 2-phenylethanol | alcohol | alcohol | acid |
| Reference Example 2 | 18.6 | 14.5 | 27.4 | 836 |
| Reference Example 7 | 11.9 | 21.2 | 37.5 | 588 |
| Reference Example 8 | 18.1 | 14.7 | 40.3 | 593 |

TABLE 18

| | Sensory Evaluation | | |
|---|---|---|---|
| Group | Average grade | Evaluation | Remarks |
| Reference Example 2 | +4.0 | ** | Favorable flavor |
| Reference Example 7 | +3.5 | ** | Favorable flavor |
| Reference Example 8 | +3.2 | ** | Favorable flavor |

### <Preliminary Test 6>

Low common salt soy sauces (Reference Examples 9, 10, 11, and 12) were obtained as in the case of Reference Example 2 except that soy sauce koji, a carbohydrate raw material, and a protein raw material were added to the aerated and agitated first moromi at the amounts listed in Table 19 in the method for producing the low common salt soy sauce of Reference Example 2 (the viable soy sauce yeast cell count per 1 g of moromi upon the addition of a carbohydrate raw material: 3×10⁷ cells) in Preliminary Test 1, and at the same time, water and an aqueous common salt solution (1.9 L in total) were added so as to result in the common salt concentration shown in Table 19.

Crystal glucose (Showa Sangyo Co., Ltd.) and starch-rich soy sauce koji having a wheat content of 70% obtained in Preliminary Test 5 were used as carbohydrate raw materials. In addition, a product obtained by puffing soybeans (Puffinin F; Kikkoman Corporation) and a commercially available wheat gluten product (VITEN; Roquette Japan) were used as protein raw materials.

TABLE 19

| | | Carbohydrate raw | | | | | Common salt |
|---|---|---|---|---|---|---|---|
| | | material | | Protein raw | | Water and | concentration |
| | | | Starch-rich | material | | aqueous | in mature |
| | Soy sauce | Glucose | soy sauce | Soybean | Wheat | common | moromi |
| Group | koji (kg) | (kg) | koji (kg) | (kg) | gluten (kg) | salt solution (L) | juice (% (w/v)) |
| Reference | 1.6 | 0.35 | | | | 1.7 | 6.5 |
| Example 2 | | | | | | | |
| Reference | | | 1.6 | 0.5 | | 1.9 | 8.0 |
| Example 9 | | | | | | | |
| Reference | 1.6 | 0.35 | | 0.5 | | 1.9 | 7.0 |
| Example 10 | | | | | | | |
| Reference | | | 1.6 | | 0.35 | 1.9 | 8.0 |
| Example 11 | | | | | | | |
| Reference | 1.6 | 0.35 | | | 0.35 | 1.9 | 7.0 |
| Example 12 | | | | | | | |

The obtained low common salt soy sauces (Reference Examples 9, 10, 11, and 12) were compared with Reference Example 2 obtained in Preliminary Test 1 (using glucose as a carbohydrate raw material). In addition, sensory evaluation was performed using a commercially available reduced common salt soy sauce (Kikkoman Corporation) as a control as in the case of Preliminary Test 1. Tables 20 to 22 show the results.

Based on the results shown in Tables 20 to 22, it is understood that a low common salt soy sauce having a favorable flavor and a high total nitrogen concentration, in which the concentration of ethanol known as an important aromatic component in soy sauce is 4.0% (v/v) or more while the 2-phenyl ethanol concentration per 1.0% (w/v) of total nitrogen concentration is 7.0 μg/ml or more, the isobutyl alcohol concentration per 1.0% (w/v) of total nitrogen concentration is 10.0 μg/ml or more, and the isoamyl alcohol concentration per 1.0% (w/v) of total nitrogen concentration is 15.0 μg/ml or more, and in which the succinic acid concentration per 1.0% (w/v) of total nitrogen concentration is 500 μg/ml or more, can be obtained without using special means.

TABLE 20

| | Low common salt soy sauce component analysis values | | | |
|---|---|---|---|---|
| | Common salt | Ethanol | Total nitrogen | |
| | concentration | concentration | concentration | |
| Group | (%(w/v)) | (%(v/v)) | (%(w/v)) | pH |
| Reference | 6.5 | 6.8 | 1.7 | 5.2 |
| Example 2 | | | | |
| Reference | 8.0 | 6.5 | 1.9 | 5.2 |
| Example 9 | | | | |
| Reference | 7.0 | 5.6 | 2.1 | 5.2 |
| Example 10 | | | | |
| Reference | 8.0 | 7.0 | 2.1 | 5.2 |
| Example 11 | | | | |
| Reference | 7.0 | 7.4 | 2.3 | 5.2 |
| Example 12 | | | | |

TABLE 21

| | Component concentration (μg/ml) per 1.0% (w/v) | | | |
|---|---|---|---|---|
| | of total nitrogen concentration | | | |
| | | Isobutyl | Isoamyl | Succinic |
| Group | 2-phenylethanol | alcohol | alcohol | acid |
| Reference Example 2 | 18.6 | 14.5 | 27.4 | 836 |
| Reference Example 9 | 12.2 | 19.2 | 25.7 | 658 |
| Reference Example 10 | 9.9 | 14.9 | 19.3 | 543 |
| Reference Example 11 | 11.5 | 18.8 | 24.5 | 557 |
| Reference Example 12 | 9.6 | 15.9 | 19.9 | 517 |

TABLE 22

| | Sensory Evaluation | | |
|---|---|---|---|
| Group | Average grade | Evaluation | Remarks |
| Reference Example 2 | +4.0 | ** | Favorable flavor |
| Reference Example 9 | +2.4 | ** | Favorable flavor |
| Reference Example 10 | +2.5 | ** | Favorable flavor |
| Reference Example 11 | +2.5 | ** | Favorable flavor |
| Reference Example 12 | +3.1 | ** | Favorable flavor |

### Preliminary Example 7

### Test of Changing the Amount of Sugar to be Added

The low common salt soy sauce of the present invention was obtained in the manner described above except that the common salt concentration of moromi was adjusted by adding soy sauce koji and glucose as a carbohydrate raw material to the aerated and agitated first moromi at amounts listed in Table 23 and further adding water and an aqueous common salt solution at amounts listed in Table 23 in the method for producing the low common salt soy sauce of Reference Example 2 (viable soy sauce yeast cell count per 1 g of moromi upon addition of carbohydrate raw material: 3×10⁷ cells) in Preliminary Example 1, followed by adequate agitation as in the case of Preliminary Example 1, fermentation, maturation, press, filtration, pasteurisation, and clarification. Accordingly, it is understood that a low common salt soy sauce, in which the concentration of ethanol known as an important aromatic component in soy sauce is 4.0% (v/v) or more while the 2-phenyl ethanol concentration per 10% (w/v) of total nitrogen concentration is 7.0 g/ml or more, the isobutyl alcohol concentration per 1.0% (w/v) of total nitrogen concentration is 10.0 μg/ml or more, and the isoamyl alcohol concentration per 1.0% (w/v) of total nitrogen concentration is 15.0 μg/ml or more, and in which the succinic acid concentration per 1.0% (w/v) of total nitrogen concentration is 500 μg/ml or more, can be obtained without using special means as shown in

TABLE 23

| | | | | Common salt |
|---|---|---|---|---|
| | Soy | | | concentration |
| | sauce | Carbohydrate | Water and | in mature |
| | koji | raw material | aqueous common | moromi |
| Group | (kg) | (glucose) (kg) | salt solution (L) | juice (% (w/v)) |
| Reference | 1.6 | 0.35 | 1.7 | 6.5 |
| Example 2 | | | | |
| Reference | 1.6 | 1.10 | 4.8 | 4.1 |
| Example 14 | | | | |
| Reference | 1.6 | 0.45 | 1.7 | 11.6 |
| Example 15 | | | | |

TABLE 24

| | | | | | | | | | Glucose |
|---|---|---|---|---|---|---|---|---|---|
| | Low common salt soy sauce | | | | Component concentration | | | | concentration |
| | component analysis values | | | | (μg/ml) per 1.0% (w/v) of total | | | | (mg/ml) per |
| | Common salt | Ethanol | Total nitrogen | | nitrogen concentration | | | | 1.0% (w/v) |
| | concentration | concentration | concentration | | 2- | Isobutyl | Isoamyl | Succinic | of total nitrogen |
| | (% (w/v)) | (% (v/v)) | (% (w/v)) | pH | phenylethanol | alcohol | alcohol | acid | concentration |
| Reference | 6.5 | 6.8 | 1.7 | 5.2 | 18.6 | 14.5 | 27.4 | 836 | 3.0 |
| Example 2 | | | | | | | | | |
| Reference | 4.1 | 9.1 | 1.4 | 5.2 | 34.3 | 39.4 | 65.2 | 960 | 4.7 |
| Example 14 | | | | | | | | | |
| Reference | 11.6 | 4.9 | 1.8 | 5.2 | 9.7 | 12.3 | 18.3 | 515 | 4.9 |
| Example 15 | | | | | | | | | |

In the present specification, the salt concentrations and the ethanol concentrations in the first moromi, the second moromi and the third moromi mean the salt concentration and the ethanol concentration in the juice obtained by separating and removing the solid content from the moromi of the stage to be analyzed using a filter paper filtration, or the like.

### Example 1

### Preparation of the First Moromi

The above soy sauce koji prepared in Preliminary Test 1 (0.8 kg) was mixed with a 18% (w/v) aqueous common salt solution (1.9 L).

Soy sauce lactic acid bacterium was added to the obtained soy sauce moromi so as to give 1×10⁵ cells per 1 g of the moromi, maintained at a moromi temperature of 15° C. for a month, wherein the raw materials were decomposed, eluted and lactic acid fermented by the soy sauce koji enzyme, thereby obtaining a soy sauce moromi (a common salt concentration of about 15% w/v), which is preferable for the soy sauce yeast to proliferate (see Table 25).

This soy sauce moromi was prepared for the total of 5 groups (Present Inventions 1 to 4 and Comparative Example 8), a soy sauce yeast (Zygosaccharomyces rouxii) was added to each group so as to give 5×10⁵ cells per 1 g of the moromi, a moromi temperature was maintained at 20° C., the moromi was aerated and agitated to prepare the first moromi having a viable soy sauce yeast cell count of 3×10⁷ cells per 1 g of the moromi. Table 25 shows the preparation of the first moromi, the common salt concentrations and the viable soy sauce yeast cell count in the first moromi (after fermentation).

TABLE 25

| | | | Common salt | Viable soy sauce |
|---|---|---|---|---|
| | | | concentration | yeast cell count |
| | | | in first moromi | in first moromi |
| | Soy sauce | Aqueous common | (after fermentation) | (after fermentation) |
| Group | koji (kg) | salt solution (L) | %(w/v) | (cell/g moromi) |
| Present Invention 1 | 0.8 | 1.9 | 15.0 | 3 × 10⁷ |
| Present Invention 2 | ″ | ″ | ″ | ″ |
| Present Invention 3 | ″ | ″ | ″ | ″ |
| Present Invention 4 | ″ | ″ | ″ | ″ |
| Comparative Example 8 | ″ | ″ | ″ | ″ |

### (Preparation of a Rice Koji)

2 kg of rice was immersed in water for 1.5 hours and drained for 1 hour. The drained rice was steamed at 100° C. for 40 minutes at normal pressure. The obtained steamed rice was cooled to room temperature, and was inoculated with a bran seed koji mold of Aspergillus oryzae (ATCC14895) (effective spore count: 1×10⁹ cells/g) at 0.1% (w/w), which was then heaped in a container (koji-buta). The container was subjected to a usual koji-making process for 48 hours to obtain a rice koji.

### (Preparation of the Second Moromi)

As shown in Table 26, the rice koji and glucose (Showa Sangyo Co., Ltd.) as carbohydrate raw materials and water or the aqueous common salt solution were added respectively in a predetermined amount to 1 kg of the first moromi to adjust the common salt concentration of the soy sauce moromi, thereby preparing the second moromi.

Then, the moromi was suitably agitated at a moromi temperature of 20° C. and fermented for 2 weeks, thereby preparing the second moromi containing common salt and ethanol as shown in Table 26. Table 26 shows the preparation of second moromi, the carbohydrate raw materials and water added to the first moromi as well as the common salt and alcohol concentrations in the second moromi (after fermentation).

TABLE 26

| | | | | Common salt | |
|---|---|---|---|---|---|
| | | | | concentration | Ethanol concentration |
| | | | Water or | in second moromi | in second moromi |
| | Rice | Glucose | aqueous common | (after fermentation) | (after fermentation) |
| Group | koji (kg) | (kg) | salt solution (L) | % (w/v) | % (v/v) |
| Present Invention 1 | 1.7 | 0.5 | 4.9 | 6.0 | 12 |
| Present Invention 2 | 1.7 | 0.5 | 4.9 | 4.0 | 12 |
| Present Invention 3 | 1.7 | 0.5 | 4.9 | 4.0 | 12 |
| Present Invention 4 | 1.7 | 0.5 | 4.9 | 6.0 | 12 |
| Comparative Example 8 | 1.7 | 0.5 | 4.9 | 8.0 | 10 |

### (Preparation of the Third Moromi)

1 kg of the second moromi was prepared for 5 groups. In each group, as shown in Table 27, a predetermined amount of the rice koji, glucose (Showa Sangyo Co., Ltd.) and water were added to prepare the third moromi. Further, 25 ml each of the culture broth containing Kyokai No. 7 yeast (sake yeast) cultured in advance was added thereto. Subsequently, the third moromi having the ethanol concentrations and the viable yeast cell counts as shown in Table 27 were prepared. The culture broth containing Kyokai No. 7 yeast (Brewing Soc, of Japan) was the broth obtained by inoculating a yeast into a YPD medium and aerobically cultured in a Sakaguchi flask at 20° C. for 20 hours.

TABLE 27

| | | | | | Ethanol | Viable yeast |
|---|---|---|---|---|---|---|
| | | | | Common salt | concentration | cell count |
| | | | | concentration | in third moromi | in third moromi |
| | | | | in third moromi | immediately | immediately |
| | Rice | Glucose | Water | (after maturation) | after preparation | after preparation |
| Group | koji (kg) | (kg) | (L) | % (w/v) | % (w/v) | (cell/g moromi) |
| Present Invention 1 | 0.4 | 0.11 | 0.16 | 4.0 | 8.0 | 1.0 × 10⁷ |
| Present Invention 2 | 0.53 | 0.15 | 0.52 | 2.0 | 6.0 | 7.5 × 10⁶ |
| Present Invention 3 | 1.1 | 0.29 | 1.9 | 1.0 | 3.0 | 3.8 × 10⁶ |
| Present Invention 4 | 1.6 | 0.43 | 3.3 | 1.0 | 2.0 | 2.5 × 10⁶ |
| Comparative Example 8 | 2.1 | 0.58 | 4.8 | 1.0 | 1.3 | 1.3 × 10⁶ |

### (Fermentation and Maturation of the Third Moromi)

The third moromi was fermented and matured suitably with agitation at a moromi temperature of 15° C. for 2 weeks. The moromi was compressed to obtain a pure soy sauce, thereby obtaining 5 types of very low common salt soy sauces.

The obtained soy sauces were subjected to the component analysis. The results are shown in Tables 28 and 29.

Table 28 shows the component analysis value 1 of the very low common salt soy sauces, and Table 29 shows the component analysis value 2 of the very low common salt soy sauces.

### (Analysis of the Indole Compound)

The analysis was carried out by gas chromatography and the presence/absence of detection was confirmed.

### (Analysis of the Aromatic Components)

The analysis was carried out by gas chromatography.

TABLE 28

| | Common salt | Ethanol | | |
|---|---|---|---|---|
| | con- | con- | Detection of | |
| | centration | centration | indole | |
| Group | % (w/v) | % (v/v) | compound | Remarks |
| Present | 4.0 | 11.0 | Not detected | Favorable flavor |
| Invention 1 | | | | |
| Present | 2.0 | 16.0 | Not detected | Favorable flavor |
| Invention 2 | | | | |
| Present | 1.0 | 18.4 | Not detected | Favorable flavor |
| Invention 3 | | | | |
| Present | 1.0 | 17.8 | Not detected | Favorable flavor |
| Invention 4 | | | | |
| Comparative | 1.0 | 17.4 | Detected | Slight foul smell |
| Example 8 | | | | |

TABLE 29

| | | | Total | | | | |
|---|---|---|---|---|---|---|---|
| | Common salt | Ethanol | nitrogen | 2-phenyl | | | |
| | concentraton | concentration | concentration | ethanol | Isobutyl | Isoamyl | Succinic |
| Group | % (w/v) | % (v/v) | % (w/v) | (#) | alcohol (#) | alcohol (#) | acid (#) |
| Present invention 1 | 4.0 | 11.0 | 0.68 | 107.2 | 87.1 | 285 | 1691 |
| Present invention 2 | 2.0 | 16 | 0.5 | 165 | 175.8 | 520.2 | 1960 |
| Present invention 3 | 1.0 | 18.4 | 0.4 | 275 | 407.3 | 773.5 | 2875 |
| Commercially- | 8.4 | 5.5 | 1.6 | 4.5 | 8.2 | 7.6 | 250 |
| available reduced | | | | | | | |
| salt soy sauce | | | | | | | |

Note: the symbol # indicates the concentration per 1.0% (w/v) of total nitrogen concentration. The unit is μg/ml.

The results shown in Tables 25 to 29 reveal that, in the method for producing the very low common salt soy sauce of the present invention, when the viable yeast cell count immediately after preparing the third moromi was less than 2×10⁶ cells per 1 g of the moromi, the ethanol concentration was 2% (v/v) or less whereby the soy sauce moromi was spoiled by spoilage bacteria during the fermentation and maturation, causing an indole compound known as a foul-smelling compound to be produced and accumulated in the soy sauce moromi, failing to obtain a favorable flavored soy sauce.

To the contrary, it is revealed that when the viable yeast cell count immediately after preparing the third moromi is 2×10⁶ cells or more per 1 g of the moromi and the ethanol concentration is 2% (v/v) or more, the moromi, even when fermented and matured, can be prevented from being spoiled, thereby obtaining a soy sauce having a high concentration of ethanol with a favorable flavor and a common salt concentration as low as 1.0 to 4.0% (w/v).

Further, the results shown in Table 29 reveal that, according to the present invention, a very low common salt soy sauce having a common salt concentration of 1.0 to 4.0% (w/v) and a total nitrogen concentration of 0.4 to 0.7% (w/v), and in which an ethanol concentration is 11.0 to 18.0% (v/v), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, a an isoamyl alcohol concentration per 1.0% (w/v) of a total nitrogen is 15.0 μg/ml or more, can be obtained.

It is also revealed that the very low common salt soy sauce having a succinic acid concentration per 1.0% (w/v) of a total nitrogen of 500 μg/ml or more is obtained.

### Example 2

In exactly the same manner as in the method for producing the very low common salt soy sauce of Example 1, first, a predetermined amount of rice koji, soy sauce koji, glucose (Showa Sangyo Co., Ltd.) and adjusted water were added as shown in Table 30 to 1 kg of the prepared first moromi and fermented to prepare the second moromi.

Subsequently, a predetermined amount of the rice koji, soy sauce koji, glucose and adjusted water were added as shown in Table 31 to the prepared second moromi to prepare the third moromi.

Then, the third moromi was fermented and matured suitably with agitation at a moromi temperature of 15° C. for 2 weeks.

The moromi was compressed to obtain a pure soy sauce, from which four types of the very low common salt soy sauces were obtained. The obtained soy sauces were subjected to the component analysis. The results are shown in Tables 30 to 33.

TABLE 30

| | | | | Water or | Common salt | Ethanol |
|---|---|---|---|---|---|---|
| | | | | aqueous | concentration | concentration |
| | | Soy | | common | in second moromi | in second moromi |
| | Rice | sauce | Glucose | salt | (after fermentation) | (after fermentation) |
| Group | koji (kg) | koji (kg) | (kg) | solution (L) | % (w/v) | % (v/v) |
| Present Invention 2 | 1.7 | — | 0.5 | 4.9 | 4.0 | 12 |
| Present Invention 5 | 1.7 | — | 0.5 | 4.9 | 4.0 | 12 |
| Present Invention 6 | — | 1.7 | 0.5 | 2.0 | 6.0 | 8 |
| Present Invention 7 | — | 1.7 | 0.5 | 2.0 | 6.0 | 8 |

TABLE 31

| | | | | | Ethanol | Viable yeast |
|---|---|---|---|---|---|---|
| | | | | | concentration | cell count |
| | | | | | in third moromi | in third moromi |
| | Rice | Soy sauce | Glucose | Water | (at preparation) | (at preparation) |
| Group | koji (kg) | koji (kg) | (kg) | (L) | % (v/v) | (cell/g moromi) |
| Present Invention 2 | 0.53 | — | 0.15 | 0.52 | 6.0 | 7.5 × 10⁶ |
| Present Invention 5 | — | 0.53 | 0.15 | 0.52 | 6.0 | 7.5 × 10⁶ |
| Present Invention 6 | 0.79 | — | 0.22 | 1.2 | 2.7 | 3.3 × 10⁶ |
| Present Invention 7 | — | 0.79 | 0.22 | 1.2 | 2.7 | 3.3 × 10⁶ |

TABLE 32

| | Common salt | Ethanol | Detection of | |
|---|---|---|---|---|
| Group | concentration %(w/v) | concentration %(v/v) | indole compound | Remarks |
| Present Invention 2 | 2.0 | 16.0 | Not detected | Favorable flavor |
| Present Invention 5 | 2.0 | 10.3 | Not detected | Favorable flavor |
| Present Invention 6 | 2.0 | 12.8 | Not detected | Favorable flavor |
| Present Invention 7 | 2.0 | 9.8 | Not detected | Favorable flavor |

TABLE 33

| | Common salt | Ethanol | Total nitrogen | | | | |
|---|---|---|---|---|---|---|---|
| | concentration | concentration | concentration | 2-phenyl | Isobutyl | Isoamyl | Succinic |
| Group | % (w/v) | % (v/v) | % (w/v) | ethanol (#) | alcohol (#) | alcohol (#) | acid (#) |
| Present Invention 2 | 2.0 | 16 | 0.5 | 165 | 175.8 | 520.2 | 1960 |
| Present Invention 5 | 2.0 | 10.3 | 1.36 | 42.8 | 53.4 | 136.5 | 706 |
| Present Invention 6 | 2.0 | 12.8 | 0.72 | 65.4 | 102.5 | 254.6 | 1111 |
| Present Invention 7 | 2.0 | 9.8 | 1.6 | 18.1 | 30.7 | 69.9 | 525 |

Note: the symbol # indicates the concentration per 1.0% (w/v) of total nitrogen concentration. The unit is μg/ml.

The results shown in Tables 30 to 33 reveal that, in the method for producing the very low common salt soy sauce of the present invention, even when the soy sauce koji rich in protein was used, in addition to the use of starch-rich rice koji, as the carbohydrate raw material to be added to the soy sauce moromi, the yeast fermentation continued vigorously, thereby consequently obtaining a very low common salt soy sauce having a high concentration of the aromatic components favorable for a soy sauce. More specifically, it is verified that a very low common salt soy sauce having a common salt concentration of 1.0 to 4.0% (w/v), and a total nitrogen concentration of 0.5 to 1.6% (w/v), and in which an ethanol concentration is 9.8 to 16.0% (v/v), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, and an isoamyl alcohol concentration per 1.0% (w/v) of a total nitrogen is 15.0 μg/ml or more, is obtained.

### Example 3

### Production of the Very Low Common Salt Soy Sauce of the Present Invention

The first moromi was prepared in the same manner as in the above Example 1. Subsequently, as shown in Table 34, the rice koji, soy sauce koji or the glucose (Showa Sangyo Co., Ltd.) and water were added respectively in a predetermined amount to 3 kg of the first moromi to adjust the common salt concentration of the soy sauce moromi, thereby preparing the second moromi

Then, the moromi was suitably agitated at a moromi temperature of 20° C. and fermented for 2 weeks, thereby preparing the second moromi (after fermentation) containing common salt and ethanol as shown in Table 34.

Subsequently, the rice koji, the soy sauce koji or the glucose (Showa Sangyo Co., Ltd.) and water were added in a predetermined amount as shown in Table 35 to 1 kg of the above second moromi. Further, 25 ml each of a culture broth containing Kyokai No. 7 yeast (sake yeast) obtained by culturing in advance was added thereto. Then the third moromi containing the ethanol concentration and the viable yeast cell count, as shown in Table 35, was prepared.

The third moromi was fermented and matured suitably with agitation at the moromi temperature of 15° C. for 2 weeks. The moromi was compressed to obtain a pure soy sauce, from which two types of the very low common salt soy sauces were obtained. The obtained soy sauces were subjected to the component analysis. The results are shown in Tables 34 to 37.

TABLE 34

| | | | | | Common salt | Ethanol |
|---|---|---|---|---|---|---|
| | | | | | concentration | concentration |
| | | | | | in second moromi | in second moromi |
| | Rice | Soy sauce | Glucose | Water | (after fermentation) | (after fermentation) |
| Group | koji (kg) | koji (kg) | (kg) | (L) | % (w/v) | % (v/v) |
| Present Invention 5 | 1.7 | — | 0.5 | 4.9 | 4.0 | 12 |

TABLE 35

| | | | | | Ethanol | Viable yeast |
|---|---|---|---|---|---|---|
| | | | | | concentration | cell count |
| | | | | | in third moromi | in third moromi |
| | Rice | Soy sauce | Glucose | Water | at preparation | at preparation |
| Group | koji (kg) | koji (kg) | (kg) | (L) | % (v/v) | (cell/g moromi) |
| Present Invention 5 | — | 0.53 | 0.15 | 0.52 | 6.0 | 7.5 × 10⁶ |

TABLE 36

| | Common salt | Ethanol | Detection of | |
|---|---|---|---|---|
| | concentration | concentration | indole | |
| Group | % (w/v) | % (v/v) | compound | Remarks |
| Present | 2.0 | 10.3 | Not detected | Favorable |
| Invention 5 | | | | flavor |

TABLE 37

| Component analysis value | TN | NaCl | Alc. | pH | Col(#) |
|---|---|---|---|---|---|
| Present Invention 5 | 1.36 | 2.0 | 10.3 | 5.5 | 43 |

Note (symbol #): Col is Japan soy sauce standard color

### (Sensory Evaluation Test)

The sensory evaluation was made using the very low common salt soy sauces of the present invention obtained in the present Example. The mixing ratio of each seasoning used in the sensory evaluation is shown in Table 38, and the results of sensory evaluation are shown in Table 39.

Table 39 shows the mixing ratio of the seasonings.

TABLE 38

| | | | | Very low common |
|---|---|---|---|---|
| | | | | salt soy sauce |
| | | Light soy | Cooking | of the present |
| Group | Feature | sauce (ml) | sake (ml) | invention (ml) |
| Present Invention Group | Very low common salt soy sauce added | 5 | — | 50 |
| Control Group | No addition | 5 | 50 | — |

### (Sensory Evaluation Method)

In accordance with Table 38, two kinds of seasonings were prepared. Using these seasonings, an asari clam soup was cooked. The cooked product was subjected to the sensory evaluation performed by 14 panelists using a paired comparison method. More specifically, the soup cooked using the seasoning containing the very low common salt soy sauce of the present invention (Present Invention Group) was compared with the soup (Control Group) cooked using the seasoning containing a commercially-available cooking sake (manufactured by Kikkoman Corporation).

In each evaluation item, the evaluation was made as, in comparison with Control Group, −4 for much weaker, −3 for very weak, −2 for weaker, −1 for slightly weaker, 0 for substantially same, 1 for slightly stronger, 2 for stronger, 3 for very stronger and 4 for much stronger. The grades in the Table are the average values of the 14 panelists, and the symbol “**,” “*,” and “-” used in the Evaluation columns refer to “significant at the 1% level of significance,” “significant at the 5% level of significance,” and “Not significant,” respectively. Typically, a light soy sauce has a common salt concentration of about 18% (w/v) and a cooking sake has a common salt concentration of about 2 to 3% (w/v), and for this reason the seasoning of the Present Invention Group was supplemented with salt so that the salt content is the same as those of Control Group. The results are shown in Table 39.

TABLE 39

| | | Soup | | | |
|---|---|---|---|---|---|
| | | stock | Asari clam | | |
| Group | | Umami | Fishy smell | Umami | Softness |
| Present | Average grade | 1.4 | −0.71 | 0.93 | 0.43 |
| Invention | Evaluation | ** | * | ** | — |
| Group | | | | | |

The results shown in Table 39 reveal that the very low common salt soy sauce of the present invention has much better action fbr imparting mamrni and removing the fishy smell of asari clam, or the like, than the commercially-available cooking sake.

All publications, patents and patent applications cited herein shall be incorporated per se by reference in the specification.

1. A very low common salt soy sauce, which has a common salt concentration of 1.0 to 4.0% (w/v) and a total nitrogen concentration of 0.2 to 3.0% (w/v), and in which an ethanol concentration is 8.0 to 20.0% (v/iv), a 2-phenylethanol concentration per 1.0% (w/v) of a total nitrogen is 7.0 μg/ml or more, an isobutyl alcohol concentration per 1.0% (w/v) of a total nitrogen is 10.0 μg/ml or more, and an isoamyl alcohol concentration per 1.0% (w/v) of a total nitrogen is 15.0 μg/ml or more.

2. The very low common salt soy sauce according claim 1, wherein the succinic acid concentration per 1.0% (w/v) of a total nitrogen is 500 μg/ml or more.

3. A method for producing a very low common salt soy sauce, which comprises, in the method for producing a soy sauce, adding a carbohydrate raw material and water or an aqueous common salt solution to a first moromi having a viable soy sauce yeast cell count of 1×10⁷ cells or more per 1 g of the moromi and fermenting to prepare a second moromi having a common salt concentration of 4.0 to 12.0% (w/v) and an ethanol concentration of 4.0 to 12.0% (v/v), subsequently adding a carbohydrate raw material and water or a salt solution to the second moromi, further adding or not adding a yeast to prepare a third moromi having a viable yeast cell count of 2×10⁶ cells or more per 1 g of the moromi and an ethanol concentration of 2.0% (v/v) or more, fermenting and maturing the third moromi to obtain a soy sauce having a common salt concentration of 1.0 to 4.0% (w/v), a total nitrogen concentration of 0.2 to 3.0% (w/v) and an ethanol concentration of 8.0 to 20.0% (v/v).

4. The method for producing a very low common salt soy sauce according to claim 3, wherein the third moromi is prepared by adding a carbohydrate raw material and water or an aqueous common salt solution to the second moromi and further adding a yeast, and
the yeast added to the second moromi is a yeast belonging to Saccharonmyces cerevisiae, Zygosaccharomyces rouxii, Torulopsis versatilis, or Torulopsis etchellsii.

5. The method for producing a very low common salt soy sauce according to claim 3, wherein the carbohydrate raw material is any of the following 1) to 4):
1) at least one member selected from the group consisting of glucose, maltose, fructose, a hydrochloric-acid-hydrolyzed starch liquid, an enzymatically saceharified starch liquid, and starch-rich soy sauce koji prepared with the use of raw materials comprising starch raw materials accounting for more than 65% (w/w) of the raw materials and protein raw materials accounting for the remaining proportion thereof, rice koji, mugi koji, maize koji, and bran koji,
2) a combination of: carbohydrate raw material A which is at least one member selected from the group consisting of glucose, maltose, fructose, a hydrochloric-acid hydrolyzed starch liquid, an enzymatically saccharified starch liquid, sucrose, a gelatinized cereal and a gelatinized root or tuber crop; and koji B which is at least one member selected from the group consisting of soy sauce koji, rice koji, mugi koji, maize koji and bran koji,
3) a combination of: the carbohydrate raw material A; protein raw material which is at least one member selected from the group consisting of soybeans, defatted soybeans, wheat gluten and corn gluten; and the koji B,
4) a combination of the starch-rich soy sauce koji and the protein raw material.
